(19) United States
(12) Patent Application Publication
(10) Pub. No.: US 2014/0325152 A1
(43) Pub. Date: Oct. 30, 2014

(54) QUADTREE BASED DATA MANAGEMENT FOR MEMORY

(71) Applicant: Samsung Electronics Company, Ltd., Suwon City (KR)

(72) Inventor: Gordon Taft, San Jose, CA (US)

(73) Assignee: Samsung Electronics Company, Ltd., Suwon City (KR)

(21) Appl. No.: 14/043,734

(22) Filed: Oct. 1, 2013

Related U.S. Application Data
(60) Provisional application No. 61/816,516, filed on Apr. 26, 2013.

(51) Int. Cl. G06F 12/08

(52) U.S. Cl. CPC G06F 12/0811
USPC 711/122

(57) ABSTRACT

A method for managing memory. The method includes executing a memory management function, and reading data from memory into a particular size array structure using the memory management function based on using quadtree structure sub-functions to scan the particular size array structure for filtering the data iteratively.

### CROSS-REFERENCE TO RELATED APPLICATIONS

This application claims the priority benefit of U.S. Provisional Patent Application Ser. No. 61/816,516, filed Apr. 26, 2013, incorporated herein by reference in its entirety.

### TECHNICAL FIELD

One or more embodiments relate generally to cache memory performance, and in particular to use of quadtree based data management for improving cache memory performance.

### BACKGROUND

The complexity of computer architectures has increased over the years. Cache architectures may each be associated with different performance, latency and capacity. Cache management processes in general, and in particular for image processing, are not designed to utilize different cache architectures for central processing units (CPUs) and graphical processing units (GPUs) without significant code changes.

### SUMMARY

In one embodiment, a method provides for managing memory. The method includes executing a memory management function, and reading data from memory into a particular size array structure using the memory management function based on using quadtree structure sub-functions to scan the particular size array structure for filtering the data iteratively.

Another embodiment provides a system comprising a processor. In one embodiment, a memory hierarchy comprises a system level memory and one or more cache memory devices arranged in a hierarchy with the system level memory. In one embodiment, a memory management module comprises a plurality of quadtree structure sub-functions. The memory management module reads data from the memory hierarchy into a particular size array structure using the quadtree structure sub-functions to scan the particular size array structure for filtering the data iteratively.

Another embodiment provides a non-transitory computer-readable medium having instructions which when executed on a computer perform a method. In one embodiment, the method comprises executing a memory management function comprising a plurality of quadtree structure sub-functions and reading data from memory into a particular size array structure using the plurality of quadtree structure sub-functions to scan the particular size array structure for filtering the data iteratively.

These and other aspects and advantages of the one or more embodiments will become apparent from the following detailed description, which, when taken in conjunction with the drawings, illustrate by way of example the principles of the one or more embodiments.

### BRIEF DESCRIPTION OF THE DRAWINGS

For a fuller understanding of the nature and advantages of the one or more embodiments, as well as a preferred mode of use, reference should be made to the following detailed description read in conjunction with the accompanying drawings, in which:

FIG. 1 shows a schematic view of a communications system, according to an embodiment.

FIG. 2 shows a block diagram of a system architecture for data management, according to an embodiment.

FIG. 3 shows an example core and cache memory hierarchy used for an embodiment.

FIG. 4 shows an example recursive structure of a quadtree for a data management process, according to an embodiment.

FIG. 5 shows an example pseudo-code for a quadtree data management process, according to an embodiment.

FIG. 6 shows an example read-dataflow of a quadtree data management process, according to an embodiment.

FIG. 7 shows another example read-dataflow of a quadtree data management process, according to an embodiment.

FIG. 8 shows a flow diagram of a quadtree data management process, according to an embodiment.

FIG. 9 is a high-level block diagram showing an information processing system comprising a computing system implementing one or more embodiments.

### DETAILED DESCRIPTION

The following description is made for the purpose of illustrating the general principles of the one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to data management using quadtree structure processing. In one embodiment, a data management process uses a quadtree approach for processing data with unknown cache hierarchy and characteristics or unspecified kernel sizes. In one embodiment, a method provides for managing memory and includes executing a memory management function. In one embodiment, data is read from memory into a particular size array structure using the memory management function based on using quadtree structure sub-functions to scan the particular size array structure for filtering the data iteratively.

Another embodiment provides a system comprising a processor and a memory hierarchy that includes a system level memory and one or more cache memory devices arranged in a hierarchy with the system level memory. In one embodiment, a memory management module comprises a plurality of quadtree structure sub-functions. The memory management module reads data from the memory hierarchy into a particular size array structure using the quadtree structure sub-functions to scan the particular size array structure for filtering the data iteratively.

In one embodiment, electronic devices may utilize the one or more embodiments. In one embodiment, electronic devices comprise one or more mobile electronic devices capable of data communication over a communication link such as a wireless communication link. Examples of such mobile device include a mobile phone device, a mobile tablet device, etc.

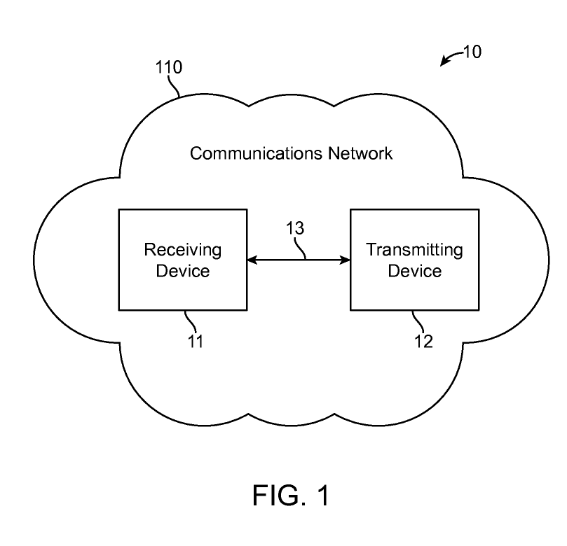

FIG. 1 is a schematic view of a communications system in accordance with one embodiment. Communications system 10 may include a communications device that initiates an outgoing communications operation (transmitting device 12) and communications network 110, which transmitting device 12 may use to initiate and conduct communications operations with other communications devices within communications network 110. For example, communications system 10 may include a communication device that receives the communications operation from the transmitting device 12 (receiving device 11). Although communications system 10 may include several transmitting devices 12 and receiving devices 11, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Transmitting device 12 and receiving device 11, when located within communications network 110, may communicate over a bidirectional communication path such as path 13. Both transmitting device 12 and receiving device 11 may be capable of initiating a communications operation and receiving an initiated communications operation.

Transmitting device 12 and receiving device 11 may include any suitable device for sending and receiving communications operations. For example, transmitting device 12 and receiving device 11 may include a media player, a cellular telephone or a landline telephone, a personal e-mail or messaging device with audio and/or video capabilities, pocket-sized personal computers such as an iPAQ Pocket PC available by Hewlett Packard Inc., of Palo Alto, Calif., personal digital assistants (PDAs), a desktop computer, a laptop computer, a server, and any other device capable of communicating wirelessly (with or without the aid of a wireless enabling accessory system) or via wired pathways (e.g., using traditional telephone wires). The communications operations may include any suitable form of communications, including for example, voice communications (e.g., telephone calls), data communications (e.g., e-mails, text messages, media messages), or combinations of these (e.g., video conferences).

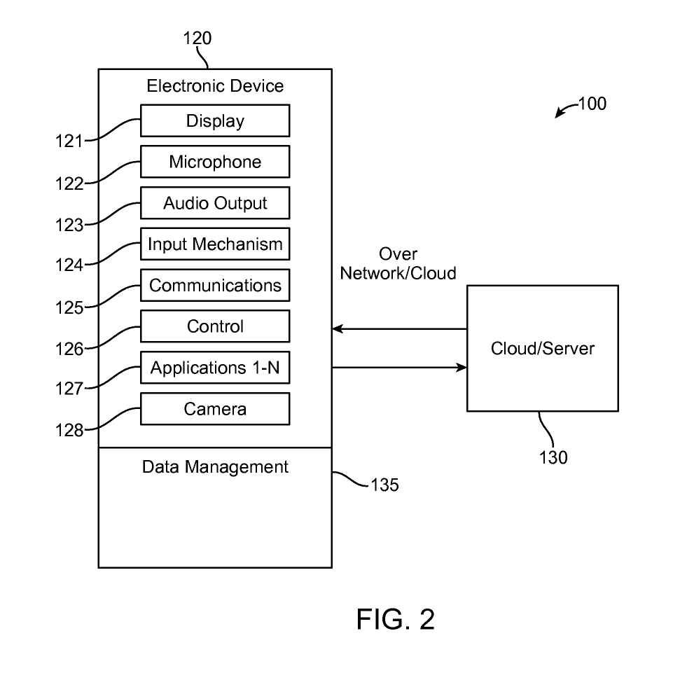

FIG. 2 shows a functional block diagram of an architecture system 100 that may be used for voice control of applications for an electronic device 120, according to an embodiment. Both transmitting device 12 and receiving device 11 may include some or all of the features of electronics device 120. In one embodiment, the electronic device 120 may comprise a display 121, a microphone 122, audio output 123, input mechanism 124, communications circuitry 125, control circuitry 126, a camera 128, a memory management module 135, and any other suitable components. In one embodiment, applications 1-N 127 are provided by providers (e.g., third-party providers, developers, etc.) and may be obtained from the cloud or server 130, communications network 110, etc., where N is a positive integer equal to or greater than 1.

In one embodiment, all of the applications employed by audio output 123, display 121, input mechanism 124, communications circuitry 125 and microphone 122 may be interconnected and managed by control circuitry 126. In one example, a hand held music player capable of transmitting music to other tuning devices may be incorporated into the electronics device 120.

In one embodiment, audio output 123 may include any suitable audio component for providing audio to the user of electronics device 120. For example, audio output 123 may include one or more speakers (e.g., mono or stereo speakers) built into electronics device 120. In some embodiments, audio output 123 may include an audio component that is remotely coupled to electronics device 120. For example, audio output 123 may include a headset, headphones or earbuds that may be coupled to communications device with a wire (e.g., coupled to electronics device 120 with a jack) or wirelessly (e.g., Bluetooth® headphones or a Bluetooth® headset).

In one embodiment, display 121 may include any suitable screen or projection system for providing a display visible to the user. For example, display 121 may include a screen (e.g., an LCD screen) that is incorporated in electronics device 120. As another example, display 121 may include a movable display or a projecting system for providing a display of content on a surface remote from electronics device 120 (e.g., a video projector). Display 121 may be operative to display content (e.g., information regarding communications operations or information regarding available media selections) under the direction of control circuitry 126.

In one embodiment, input mechanism 124 may be any suitable mechanism or user interface for providing user inputs or instructions to electronics device 120. Input mechanism 124 may take a variety of forms, such as a button, keypad, dial, a click wheel, or a touch screen. The input mechanism 124 may include a multi-touch screen.

In one embodiment, communications circuitry 125 may be any suitable communications circuitry operative to connect to a communications network (e.g., communications network 110, FIG. 1) and to transmit communications operations and media from the electronics device 120 to other devices within the communications network. Communications circuitry 125 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 125 may be operative to create a communications network using any suitable communications protocol. For example, communications circuitry 125 may create a short-range communications network using a short-range communications protocol to connect to other communications devices. For example, communications circuitry 125 may be operative to create a local communications network using the Bluetooth® protocol to couple the electronics device 120 with a Bluetooth® headset.

In one embodiment, control circuitry 126 may be operative to control the operations and performance of the electronics device 120. Control circuitry 126 may include, for example, a processor, a bus (e.g., for sending instructions to the other components of the electronics device 120), memory, storage, or any other suitable component for controlling the operations of the electronics device 120. In some embodiments, a processor may drive the display and process inputs received from the user interface. The memory and storage may include, for example, cache, Flash memory, ROM, and/or RAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 126 may be operative to perform the operations of one or more applications implemented on the electronics device 120. Any suitable number or type of applications may be implemented. Although the following discussion will enumerate different applications, it will be understood that some or all of the applications may be combined into one or more applications. For example, the electronics device 120 may include an automatic speech recognition (ASR) application, a dialog application, a map application, a media application (e.g., QuickTime, MobileMusic.app, or MobileVideo.app). In some embodiments, the electronics device 120 may include one or several applications operative to perform communications operations. For example, the electronics device 120 may include a messaging application, a mail application, a voicemail application, an instant messaging application (e.g., for chatting), a videoconferencing application, a fax application, a voice over Internet protocol (VoIP) application, or any other suitable application for performing any suitable communications operation.

In some embodiments, the electronics device 120 may include microphone 122. For example, electronics device 120 may include microphone 122 to allow the user to transmit audio (e.g., voice audio) for speech control and navigation of applications 1-N 127, during a communications operation or as a means of establishing a communications operation or as an alternate to using a physical user interface. Microphone 122 may be incorporated in electronics device 120, or may be remotely coupled to the electronics device 120. For example, microphone 122 may be incorporated in wired headphones, microphone 122 may be incorporated in a wireless headset, may be incorporated in a remote control device, etc.

In one embodiment, the electronics device 120 may include any other component suitable for performing a communications operation. For example, the electronics device 120 may include a power supply, ports or interfaces for coupling to a host device, a secondary input mechanism (e.g., an ON/OFF switch), or any other suitable component.

In one embodiment, the memory management module 135 uses a quadtree based approach to process (e.g., read, scan, etc.) data in an iterative order. In one embodiment, the memory management module 135 processes data with small data elements (e.g., pixels) or data sets containing many data elements recursively for varying systems (e.g., systems with unknown cache hierarchy levels or unspecified kernel sizes).

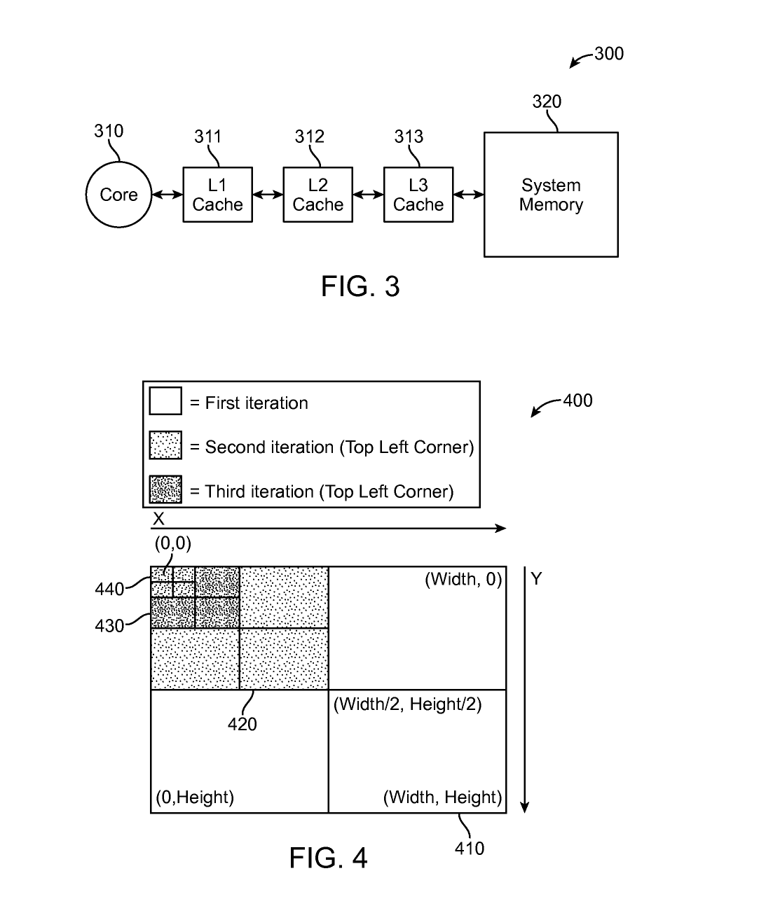

FIG. 3 shows an example core and cache memory hierarchy system 300 used for one or more embodiments. In one embodiment, the hierarchy cache architecture of system 300 is structured in dependence of performance, latency and size. The closest cache to the core 310 (e.g., central processor unit (CPU) is known as L1 cache 311 has the highest data throughput, lowest latency and smallest size as compared to other cache levels, such as L2 cache 312, L3 cache 313, etc.

In comparison to L1 cache 311, the other levels of cache (L2 cache 312, L3 cache 313, etc.) are slower and larger in size, but still faster as compared to the system memory 320. In standard CPUs, a bus system connects the CPU core(s) (e.g., core 310, etc.) with one or more cache memory devices and system memory in a hierarchy order. In one embodiment, to utilize the cache structure (e.g., hierarchy of L1 cache 311, L2 cache 312, L3 cache 313, etc.) in an optimal process, a recursive approach uses a quadtree based process to execute kernels (e.g., sub-functions). In one or more embodiments, the quadtree based process utilizes the hierarchy cache architecture automatically without additional complexity and calculation overhead for scanning data, which is distinguishable from blocking processes that split data (e.g., image data) and process the data in one section before starting the next section.

FIG. 4 shows an example recursive structure 400 of a quadtree for a data management process, according to an embodiment. A quadtree is a recursive tree structure in which each internal node has exactly four children. The recursive structure 400 shows an example of the quadtree structure with quadtrees 410, 420, 430 and 440. In one embodiment, the quadtrees 410, 420, 430 and 440 are processed iteratively in order, where the first iteration processes data in quadtree 410, the second iteration processes data in quadtree 420, the third iteration processes data in quadtree 430, the fourth iteration processes data in quadtree 440, etc.

In one embodiment, a quadtree memory management process executes a kernel-function, and the kernel function reads the data from the system memory (e.g., system memory 320, FIG. 3) in dependence of the quadtree given Cartesian coordinates (x, y) for a given range (e.g., width/2, height/2).

In one or more embodiments, all generated coordinates are close to the previous coordinates in a hierarchy order. In one embodiment, if there is an overlapping of data from a previous and current iteration, the quadtree memory management process delivers the data directly from the cache levels (e.g., L1 cache 311, L2 cache 312, L3 cache 313, etc.) in a hierarchy order.

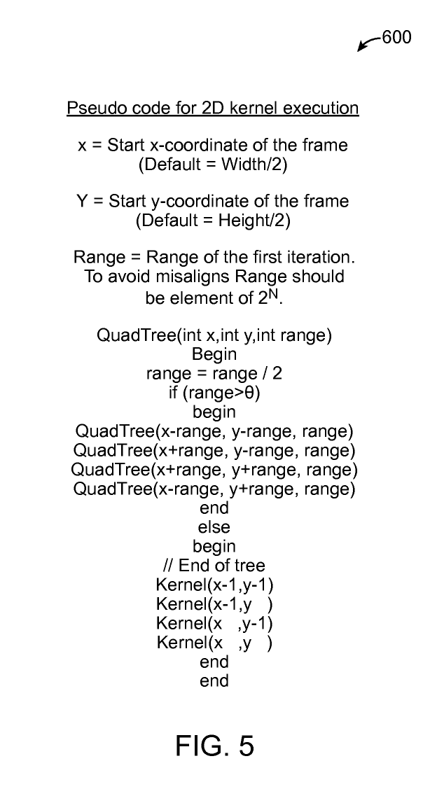

FIG. 5 shows an example pseudo-code for a quadtree data management process 600, according to an embodiment. In one embodiment, through the recursive data structure of the quadtrees, the quadtree data management process 600 splits data (e.g., data of an image) in four sub-sections, until reaching a section distance of two. In one embodiment, to avoid fractions, misaligns, and to improve performance the range remains with a 2X values, where x is a positive integer ≧ to 1. In one embodiment, integer division may be replaced with a shift operation (e.g., r>>=1).

In one embodiment, the quadtree data management process 600 generates the quadtree sub-functions at compile time, where a compiler generates a specific start condition and sub-functions with an end condition quadtree <0> that operates completely branchless at runtime.

In one embodiment, the quadtree data management process 600 may employ parallelization where different cores (e.g., CPUs, core 310, FIG. 3) execute the different quadtree sub-functions.

In one embodiment, the quadtree data management process 600 uses flexible border checking and over-scans an entire data segment (e.g., data comprising a complete image). In one embodiment, at runtime, the quadtree data management process 600 verifies if it is out of range and skips unnecessary sub-scans.

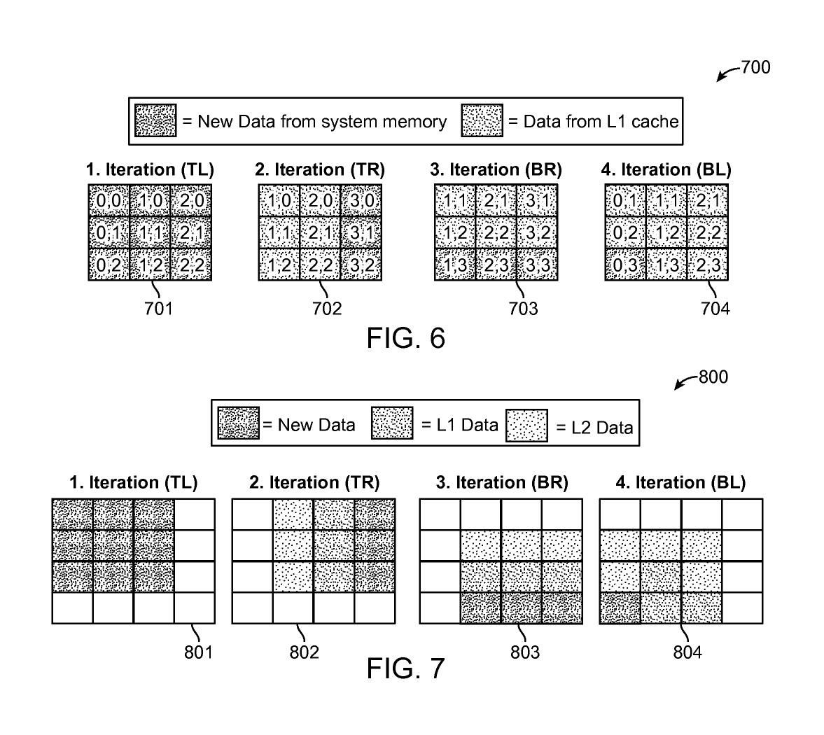

FIG. 6 shows an example read-dataflow 700 of a quadtree data management process, according to an embodiment. In one example embodiment, the quadtree data management process is shown in the read-dataflow 700 to illustrate the effects of cache management for a simple 3×3 filter kernel. In one example embodiment, for the end of the quadtree, it is assumed that the quadtree data management process works on the smallest data elements (e.g., pixels) and reached the top left corner.

In one embodiment, the example shows four iterations 701-704, where the first iteration 701 reads new data from system memory (e.g., system memory 320, FIG. 3) into the 3×3 sized filter kernel operating on the top left portion of the 3×3 sized filter kernel. In one embodiment, the second iteration 702 reads new data from the system memory and data from the L1 cache (e.g., L1 cache 311, FIG. 3) into the 3×3 sized filter kernel operating on the top right portion of the 3×3 sized filter kernel. In one embodiment, the third iteration 703 reads new data from the system memory and data from the L1 cache into the 3×3 sized filter kernel operating on the bottom right portion of the 3×3 sized filter kernel. In one embodiment, the fourth iteration 704 reads new data from the system memory and data from the L1 cache into the 3×3 sized filter kernel operating on the bottom left portion of the 3×3 sized filter kernel.

FIG. 7 shows an example read-dataflow 800 of a quadtree data management process, according to an embodiment. In one example embodiment, it is assumed that the quadtree data management process operates on a data set level, where each data set contains several data elements. In this example embodiment, the L1 cache (e.g., L1 cache 311, FIG. 3) may hold only three data sets and the kernel size is increased from the example embodiment shown in FIG. 6. In one example embodiment, the read-dataflow 800 shows the advantage of using quadtrees for data handling with unknown cache hierarchy levels/size and different/unknown kernel sizes by applying the quadtree data management process.

In one embodiment, the example shows four iterations 801-804, where the first iteration 801 reads new data from system memory (e.g., system memory 320, FIG. 3) into the filter kernel operating on the top left portion of the filter kernel. In one embodiment, the second iteration 802 reads new data from the system memory and data from the L1 cache (e.g., L1 cache 311, FIG. 3) and L2 cache (e.g., L2 cache 312) into the filter kernel operating on the top right portion of the filter kernel. In one embodiment, the third iteration 803 reads new data from the system memory and data from the L1 cache and L2 cache into the filter kernel operating on the bottom right portion of the filter kernel. In one embodiment, the fourth iteration 804 reads new data from the system memory and data from the L1 cache and the L2 cache into the filter kernel operating on the bottom left portion of the filter kernel.

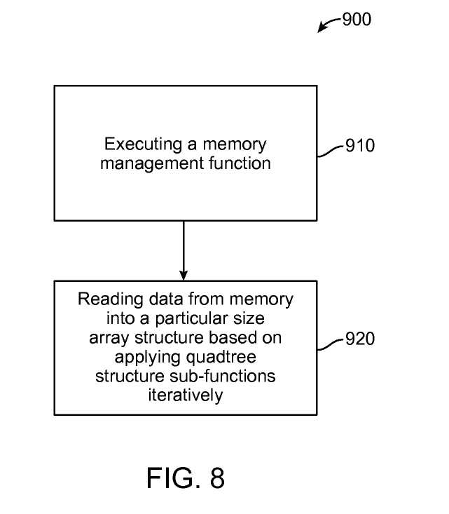

FIG. 8 shows a flow diagram of a quadtree data management process 900, according to an embodiment. In one embodiment, in block 910 a memory management function (e.g., memory management process 600, FIG. 6) is executed on a device, such as a mobile device, a computer, CPU, core, multi-core system, server, etc. In one embodiment, in block 920, data is read from memory (e.g., system memory, cache memory (e.g., L1 cache, L2 cache, L3 cache, etc.) into a particular size array structure (e.g., based on type of data, data set size, system cache hierarchy, kernel size, etc.) using the memory management function based on using quadtree structure sub-functions to scan the particular size array structure for filtering the data iteratively.

In one embodiment, the memory comprises a hierarchy order of memory devices including system level memory and a plurality of hierarchical cache memory devices, and the particular size array structure is based on kernel size. In one embodiment, the process 900 further generates quadtree multi-dimensional coordinates for starting locations for each quadtree structure sub-function for traversal of the array structure.

In one embodiment, the multi-dimensional coordinates are based on Cartesian coordinates. In one embodiment, each generated quadtree multi-dimensional coordinates for each quadtree sub-function are in proximity to previous generated coordinates in a hierarchy order. In one embodiment, in process 900 upon an overlapping of data between a previous iteration and a current iteration of quadtree structure sub-functions, data is delivered from cache memory directly in a hierarchy order.

In one embodiment, the memory management function comprises four quadtree structure sub-functions. In one embodiment, the quadtree structure comprises one or more internal nodes each having four child nodes. In one embodiment, a multi-cache hierarchy is scanned by the memory management function automatically using each of the quadtree structure sub-functions regardless of a number of cache levels for the plurality of hierarchical cache memory devices. In one embodiment, a multi-cache hierarchy is scanned by the memory management function automatically using each of the quadtree structure sub-functions regardless of a number of cache levels for the plurality of hierarchical cache memory devices or unspecified kernel size.

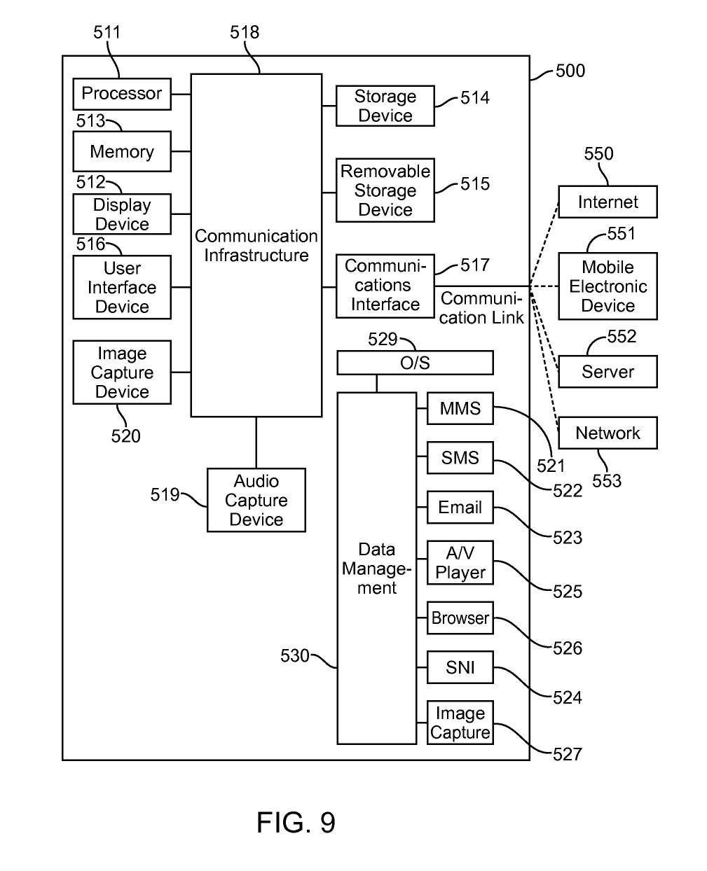

FIG. 9 is a high-level block diagram showing an information processing system comprising a computing system 500 implementing one or more embodiments. The system 500 includes one or more processors 511 (e.g., ASIC, CPU, etc.), and can further include an electronic display device 512 (for displaying graphics, text, and other data), a main memory 513 (e.g., random access memory (RAM), cache devices, etc.), storage device 514 (e.g., hard disk drive), removable storage device 515 (e.g., removable storage drive, removable memory module, a magnetic tape drive, optical disk drive, computer-readable medium having stored therein computer software and/or data), user interface device 516 (e.g., keyboard, touch screen, keypad, pointing device), and a communication interface 517 (e.g., modem, wireless transceiver (such as WiFi, Cellular), a network interface (such as an Ethernet card), a communications port, or a PCMCIA slot and card).

The communication interface 517 allows software and data to be transferred between the computer system and external devices through the Internet 550, mobile electronic device 551, a server 552, a network 553, etc. The system 500 further includes a communications infrastructure 518 (e.g., a communications bus, cross-over bar, or network) to which the aforementioned devices/modules 511 through 517 are connected.

The information transferred via communications interface 517 may be in the form of signals such as electronic, electromagnetic, optical, or other signals capable of being received by communications interface 517, via a communication link that carries signals and may be implemented using wire or cable, fiber optics, a phone line, a cellular phone link, an radio frequency (RF) link, and/or other communication channels.

In one implementation of one or more embodiments in a mobile wireless device (e.g., a mobile phone, tablet, wearable device, etc.), the system 500 further includes an image capture device, such as a camera (e.g., camera 128, FIG. 2). The system 500 may further include application modules as MMS module 521, SMS module 522, email module 523, social network interface (SNI) module 524, audio/video (AV) player 525, web browser 526, image capture module 527, etc.

In one embodiment, the system 500 includes a data management module 530 that may implement a process using quadtree sub-functions for reading data, scanning data, etc. In one embodiment, the data management module 530 may implement the data management process 600 (FIG. 6). In one embodiment, the data management module 530 along with an operating system 529 may be implemented as executable code residing in a memory of the system 500. In another embodiment, the data management module 530 may be provided in hardware, firmware, etc.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of the one or more embodiments.

Though the one or more embodiments have been described with reference to certain versions thereof; however, other versions are possible. Therefore, the spirit and scope of the appended claims should not be limited to the description of the preferred versions contained herein.

What is claimed is:

1. A method for managing memory, comprising:
executing a memory management function; and
reading data from memory into a particular size array structure using the memory management function based on using quadtree structure sub-functions to scan the particular size array structure for filtering the data iteratively.

2. The method of claim 1, wherein the memory comprises a hierarchy order of memory devices including system level memory and a plurality of hierarchical cache memory devices, and the particular size array structure is based on kernel size.

3. The method of claim 2, further comprising generating quadtree multi-dimensional coordinates for starting locations for each quadtree structure sub-function for traversal of the array structure.

4. The method of claim 3, wherein the multi-dimensional coordinates are based on Cartesian coordinates.

5. The method of claim 3, wherein each generated quadtree multi-dimensional coordinates for each quadtree sub-function are in proximity to previous generated coordinates in a hierarchy order.

6. The method of claim 5, wherein upon an overlapping of data between a previous iteration and a current iteration of quadtree structure sub-functions, data is delivered from cache memory directly in a hierarchy order.

7. The method of claim 1, wherein the memory management function comprises four quadtree structure sub-functions.

8. The method of claim 7, wherein the quadtree structure comprises one or more internal nodes each having four child nodes.

9. The method of claim 8, wherein a multi-cache hierarchy is scanned by the memory management function automatically using each of the quadtree structure sub-functions regardless of a number of cache levels for the plurality of hierarchical cache memory devices.

10. The method of claim 8, wherein a multi-cache hierarchy is scanned by the memory management function automatically using each of the quadtree structure sub-functions regardless of a number of cache levels for the plurality of hierarchical cache memory devices or unspecified kernel size.

11. A system comprising:
a processor;
a memory hierarchy comprising a system level memory and one or more cache memory devices arranged in a hierarchy with the system level memory; and
a memory management module comprising a plurality of quadtree structure sub-functions, the memory management module reads data from the memory hierarchy into a particular size array structure using the quadtree structure sub-functions to scan the particular size array structure for filtering the data iteratively.

12. The system of claim 11, wherein the particular size array structure is based on kernel size.

13. The system of claim 12, wherein the memory management module generates quadtree multi-dimensional coordinates for starting locations for each quadtree structure sub-function for scanning the array structure.

14. The system of claim 13, wherein the multi-dimensional coordinates are based on Cartesian coordinates.

15. The system of claim 13, wherein each generated quadtree multi-dimensional coordinates for each quadtree sub-function are in proximity to previous generated coordinates in a hierarchy order.

16. The system of claim 15, wherein upon an overlapping of data between a previous iteration and a current iteration of using quadtree structure sub-functions, data is delivered from the one or more cache memory devices directly in a hierarchy order.

17. The system of claim 11, wherein the memory management module uses four quadtree structure sub-functions.

18. The system of claim 17, wherein the quadtree structure comprises one or more internal nodes each having four child nodes.

19. The system of claim 18, wherein the memory hierarchy is scanned by the memory management module automatically using each of the quadtree structure sub-functions regardless of a number of cache levels for the one or more cache memory devices.

20. The system of claim 18, wherein the memory hierarchy is scanned by the memory management module automatically using each of the quadtree structure sub-functions regardless of a number of cache levels for the one or more cache memory devices or unspecified kernel size.

21. A non-transitory computer-readable medium having instructions which when executed on a computer perform a method comprising:
executing a memory management function comprising a plurality of quadtree structure sub-functions; and
reading data from memory into a particular size array structure using the plurality of quadtree structure sub-functions to scan the particular size array structure for filtering the data iteratively.

22. The medium of claim 21, wherein the memory comprises a hierarchy order of memory devices including system level memory and a plurality of hierarchical cache memory devices, and the particular size array structure is based on kernel size.

23. The medium of claim 22, further comprising generating quadtree multi-dimensional coordinates for starting locations for each quadtree structure sub-function for traversal of the array structure.

24. The medium of claim 23, wherein the multi-dimensional coordinates are based on Cartesian coordinates.

25. The medium of claim 23, wherein each generated quadtree multi-dimensional coordinates for each quadtree sub-function are in proximity to previous generated coordinates in a hierarchy order.

26. The medium of claim 25, wherein upon an overlapping of data between a previous iteration and a current iteration of quadtree structure sub-functions, data is delivered from cache memory directly in a hierarchy order.

27. The medium of claim 21, wherein the memory management function comprises four quadtree structure sub-functions.

28. The medium of claim 27, wherein the quadtree structure comprises one or more internal nodes each having four child nodes.

29. The medium of claim 28, wherein a multi-cache hierarchy is scanned by the memory management function automatically using each of the quadtree structure sub-functions regardless of a number of cache levels for the plurality of hierarchical cache memory devices.

30. The medium of claim 28, wherein a multi-cache hierarchy is scanned by the memory management function automatically using each of the quadtree structure sub-functions regardless of a number of cache levels for the plurality of hierarchical cache memory devices or unspecified kernel size.
